(19) United States
(12) Patent Application Publication
(10) Pub. No.: US 2026/0195181 A1
(43) Pub. Date: Jul. 9, 2026

(54) HARDWARE AWARE ORCHESTRATION

(71) Applicant: Dell Products L.P., Round Rock, TX (US)

(72) Inventors: Haijun ZHONG, Shanghai (CN); Hongyao TANG, Shanghai (CN); XiaoJun WU, Shanghai (CN)

(73) Assignee: Dell Products L.P., Round Rock, TX (US)

(21) Appl. No.: 19/030,327

(22) Filed: Jan. 17, 2025

(30) Foreign Application Priority Data
Jan. 3, 2025 (CN) 202510009386.0

(51) Int. Cl. G06F 9/50

(52) U.S. Cl. CPC G06F 9/5027

(57) ABSTRACT

An information handling system may include at least one processor and a memory. The information handling system may be configured to: execute a workload orchestrator configured to distribute workloads to a plurality of nodes for execution thereon; receive an event notification indicating a hardware problem associated with a particular node; translate the event notification into an orchestration status for the particular node; and based on the orchestration status, halt distribution of workloads to the particular node.

### TECHNICAL FIELD

The present disclosure relates in general to information handling systems, and more particularly to orchestration of workloads in clusters of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and needs and requirements vary between information handling different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In the field of cloud-native computing, a cloud microservice orchestration system such as Kubernetes (K8s) is sometimes used to manage deployments. For the sake of concreteness and exposition, this disclosure will discuss in detail the example of a Kubernetes cluster. One of ordinary skill in the art with the benefit of this disclosure will appreciate its applicability to other workload orchestration implementations, however.

Kubernetes generally allocates workloads to the different nodes of a cluster based on the status of the nodes. In existing implementations, the node status information that Kubernetes relies on in making these determinations is generally limited to OS-level information (or even higher-level information), lacking the lower-level hardware-specific information.

This setup may be acceptable for some deployments (e.g., using stateless pods) in which the pods are running on many nodes, and so the failure of any one node is not critical. However, for many enterprise applications running with stateful pods, the effort required for failover is increased.

It is possible to proactively predict at least some types of failures of individual nodes based on their hardware inventory and/or hardware event logs. For example, inventory information such as known-bad components, outdated firmware or drivers, etc. may have some predictive power. Hardware event logs reflecting errors that have occurred may also be predictive of node failure.

Embodiments may allow Kubernetes to reduce the failure rate of pods by taking such hardware-level data into account when orchestrating workloads.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with workload orchestration may be reduced or eliminated.

In accordance with embodiments of the present disclosure, an information handling system may include at least one processor and a memory. The information handling system may be configured to: execute a workload orchestrator configured to distribute workloads to a plurality of nodes for execution thereon; receive an event notification indicating a hardware problem associated with a particular node; translate the event notification into an orchestration status for the particular node; and based on the orchestration status, halt distribution of workloads to the particular node.

In accordance with these and other embodiments of the present disclosure, a method may include an information handling system executing a workload orchestrator configured to distribute workloads to a plurality of nodes for execution thereon; the information handling system receiving an event notification indicating a hardware problem associated with a particular node; the information handling system translating the event notification into an orchestration status for the particular node; and based on the orchestration status, the information handling system halting distribution of workloads to the particular node.

In accordance with these and other embodiments of the present disclosure, an article of manufacture may include a non-transitory, computer-readable medium having computer-executable instructions thereon that are executable by a processor of an information handling system for: executing a workload orchestrator configured to distribute workloads to a plurality of nodes for execution thereon; receiving an event notification indicating a hardware problem associated with a particular node; translating the event notification into an orchestration status for the particular node; and based on the orchestration status, halting distribution of workloads to the particular node.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example architecture, in accordance with embodiments of the present disclosure.

### DETAILED DESCRIPTION

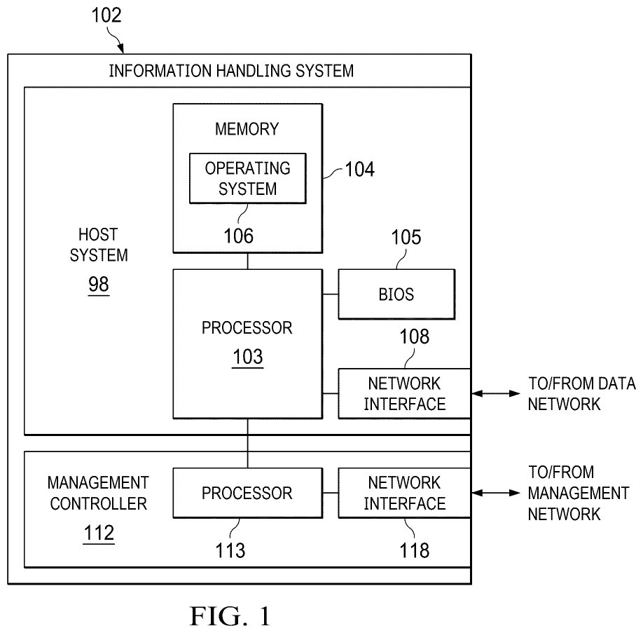

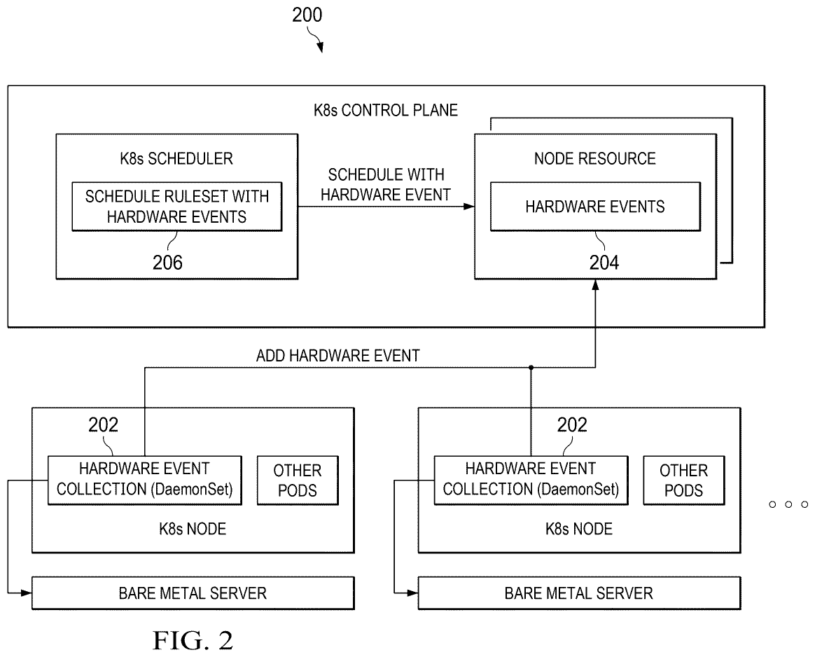

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality f servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

s shown in FIG. 1, memory 104 may have stored thereon an operating system 106. Operating system 106 may comprise any program of executable instructions for aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

Information handling system 102 may comprise a node of a cluster information handling system. As discussed above, embodiments of this disclosure provide for integration of hardware-level information that is predictive of node failure into such a workload orchestration system as Kubernetes.

Kubernetes defines its resources in terms of nodes. A node includes the specification and status of an underlying information handling system. Embodiments of this disclosure may extend the node resource definition to include hardware inventory and event information. Based on that information, the orchestration rule set in Kubernetes may be defined in such a way as to enhance the orchestration of workloads across nodes, reducing the failure rate of pods. In particular, the rule set may translate the node-level hardware events into Kubernetes events, which can be used for resource orchestration by Kubernetes.

FIG. 2 illustrates an example of an architecture 200 for integrating hardware-level events into Kubernetes workload orchestration.

In this embodiment, a plurality of Kubernetes nodes are run on bare metal servers. In addition to its normal workload pods, each node also hosts a hardware event collection DaemonSet 202 to collect the hardware inventory and event information from the underlying bare metal server. This hardware information may be sourced from a management controller or any other suitable sources within the bare metal server.

The hardware event collection DaemonSet 202 may add hardware events 204 to the node resource information within the Kubernetes control plane. In particular, the node resource information may be extended in its event section to include the hardware events. In one implementation, the hardware event format may follow the standard node resource event format for compatibility with other events.

The Kubernetes scheduler may then define a customized rule set 206 with hardware events. The scheduler may orchestrate the workload by dispatching work to the nodes based on its own predefined rules and the new customized rule set 206. For example, the scheduler may determine not to deploy new workloads to a node that has a disk failure event, etc.

The rule set design may be configured to translate the hardware events into Kubernetes events. For example, a hardware event such as “remote connectivity unavailable, primary failed” may be translated into the NodeNotReady event in Kubernetes, because the primary and first connection is not ready, and so the node should not be in the ready list for the first-time scheduling work.

A hardware event such “remote connectivity as unavailable, backup failed”, however, may be translated into the NodeNotSchedulable class, because this event indicates that even the backup connection is failed, and so the node should be considered unavailable for any workload scheduling. Table 1 below provides a few examples of hardware events and their corresponding Kubernetes events. One of ordinary skill in the art will appreciate how Table 1 may be extended to other types of hardware events, other orchestration systems, etc.

TABLE 1

| Category | Hardware Event | K8s Event |
|---|---|---|
| Remote connectivity | Remote connectivity | NodeNotReady |
| | unavailable, | |
| | primary failed | |
| | Remote connectivity | NodeNotSchedulable |
| | unavailable, backup | |
| | failed | |
| | Remote connectivity | NodeReady |
| | succeeded | |
| Power supply | Host power supply | NodeNotSchedulable |
| | lost | |
| | Host power supply | NodeReady |
| | healed | |
| . . . | Host hardware | NodeNotSchedulable |
| | temperature too | |
| | high | |
| | Host hardware | NodeNotSchedulable |
| | component failure | |

In short, a table or other data structure may provide a correspondence between hardware-level events and the workload orchestration statuses that they imply. This data structure may be provided by the hardware event collection DaemonSet 202 or the control plane in various embodiments. It may also be extensible, such that a user may add new entries to the data structure to address new types hardware events.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S. C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
execute a workload orchestrator configured to distribute workloads to a plurality of nodes for execution thereon;
receive an event notification indicating a hardware problem associated with a particular node;
translate the event notification into an orchestration status for the particular node; and
based on the orchestration status, halt distribution of workloads to the particular node.

2. The information handling system of claim 1, wherein the workload orchestrator is a microservices workload orchestrator.

3. The information handling system of claim 1, wherein the workload orchestrator is Kubernetes, and wherein the event notification indicating the hardware problem is received from a hardware event collection DaemonSet executing on the particular node.

4. The information handling system of claim 1, wherein translating the event notification into the orchestration status comprises consulting a lookup table.

5. The information handling system of claim 4, wherein the lookup table is user-extensible.

6. The information handling system of claim 1, wherein the event notification indicating the hardware problem is received from a baseboard management controller of the particular node.

7. A method comprising:
an information handling system executing a workload orchestrator configured to distribute workloads to a plurality of nodes for execution thereon;
the information handling system receiving an event notification indicating a hardware problem associated with a particular node;
the information handling system translating the event notification into an orchestration status for the particular node; and
based on the orchestration status, the information handling system halting distribution of workloads to the particular node.

8. The method of claim 7, wherein the workload orchestrator is a microservices workload orchestrator.

9. The method of claim 7, wherein the workload orchestrator is Kubernetes, and wherein the event notification indicating the hardware problem is received from a hardware event collection DaemonSet executing on the particular node.

10. The method of claim 7, wherein translating the event notification into the orchestration status comprises consulting a lookup table.

11. The method of claim 10, wherein the lookup table is user-extensible.

12. The method of claim 7, wherein the event notification indicating the hardware problem is received from a baseboard management controller of the particular node.

13. An article of manufacture comprising a non-transitory, computer-readable medium having computer-executable instructions thereon that are executable by a processor of an information handling system for:
executing a workload orchestrator configured to distribute workloads to a plurality of nodes for execution thereon;
receiving an event notification indicating a hardware problem associated with a particular node;
translating the event notification into an orchestration status for the particular node; and
based on the orchestration status, halting distribution of workloads to the particular node.

14. The article of manufacture of claim 13, wherein the workload orchestrator is a microservices workload orchestrator.

15. The article of manufacture of claim 13, wherein the workload orchestrator is Kubernetes, and wherein the event notification indicating the hardware problem is received from a hardware event collection DaemonSet executing on the particular node.

16. The article of manufacture of claim 13, wherein translating the event notification into the orchestration status comprises consulting a lookup table.

17. The article of manufacture of claim 16, wherein the lookup table is user-extensible.

18. The article of manufacture of claim 13, wherein the event notification indicating the hardware problem is received from a baseboard management controller of the particular node.
